(19) United States
(12) Patent Application Publication
(10) Pub. No.: US 2009/0210622 A1
(43) Pub. Date: Aug. 20, 2009

(54) COMPRESSED CACHE IN A CONTROLLER PARTITION

(76) Inventors: Stefan Birrer, Evanston, IL (US); David Dardin Chambliss, Morgan Hill, CA (US); Binny Sher Gill, Auburn, MA (US); Matthew Joseph Kalos, Tucson, AZ (US); Prashant Pandey, San Jose, CA (US)

Correspondence Address: IBM - ARC;SHIMOKAJI & ASSOCIATES, P.C., 8911 RESEARCH DRIVE, IRVINE, CA, 92618, US

(21) Appl. No.: 12/033,271

(22) Filed: Feb. 19, 2008

(51) Int. Cl. G06F 12/00

(52) U.S. Cl. 711/118; 711/E12.001

(57) ABSTRACT

A method of extending functionality of a data storage facility by adding to the primary storage system new functions using extension function subsystems is disclosed. One example of extending the functionality includes compressing and caching data in a data storage facility to improve storage and access performance of the data storage facility. A primary storage system queries a data storage extension system for availability of data tracks. If the primary storage system does not receive a response or the data tracks from the data storage extension system, it continues caching by fetching data tracks from a disk storage system. The storage extension system manages compression/decompression of data tracks in response to messages from the primary storage system. Data tracks transferred from the data storage extension system to the primary storage system are marked as stale at the data storage extension system and are made available for deletion.

### BACKGROUND OF THE INVENTION

The present invention relates generally to the field of data caching and in particular to extending caching capacity of a data storage system.

Many of today's computer systems, such as web servers or database management systems perform tasks that require high performance data access and storage. Such systems implement data storage and retrieval function using a storage controller system that is responsible for managing movement of data in and out of storage. A variety of options to store data are available in conventional art—for example hard drives, optical discs, silicon memories, etc. Typical cost effective systems that tend to have higher bytes stored per dollar tend to have slower memory access speeds. As a result, conventional art storage controllers perform speculative data caching, often just referred to as data caching, to improve responsiveness of data access for a requesting application.

Data caching refers to a technique in which the storage controller system makes a guess about data tracks that will be requested next and speculatively transfers the data to a faster access memory, called cache. For example, when the storage data controller receives request for a web page, it may speculatively cache data files that a user can access by clicking on links embedded within the web page. When the user clicks on a link in the web page, his data comes to him quickly, because the data is now transferred for the user from the cache instead of the slower speed disk storage system.

Although caching thus provides better responsiveness to data access requests, the caching capability of a deployed caching system will be limited to the size of cache memory. Caching data in compressed form allows for local storage of a larger amount of data at the expense of having to perform compression before writing to and decompression before reading from the cache.

Better methodologies and tools are needed to expand available cache size in a storage system.

### SUMMARY OF THE INVENTION

In one aspect of the present invention, a method of adding a new functionality to a primary storage system comprising steps of establishing communication between the primary storage system and an extension function subsystem; registering capabilities of the extension function subsystem with said primary storage system; specifying to the primary storage system at least one event; and if the event occurs, sending a message from the primary storage system to the extension function subsystem is disclosed.

In another aspect of the present invention, a method of caching a plurality of data tracks in a data storage extension system is disclosed. The method comprises the steps of compressing at least one of the plurality of data tracks to a compressed format, receiving a data track request from a primary storage system, decompressing at least one of the plurality of data tracks to produce decompressed data tracks, transferring at least one of the decompressed data tracks to the primary storage system, performing a determination of whether at least one of the plurality of data tracks in compressed format is stale; and deleting at least one of the plurality of data tracks in compressed format in response to said determination.

In another aspect of the present invention, a computer program product comprising a computer useable medium including a computer readable program, wherein the computer readable program when executed on a computer causes the computer to increase available cache capacity of a primary storage system is disclosed. The computer program product includes computer usable program code for communicating with a plurality of application instances, computer usable program code for establishing communication between the primary storage system and a data storage extension system, computer usable program code for querying the data storage extension system for availability of a data track, computer usable program code for deciding availability of the data track within the data storage extension system and if the data track is available in the data storage extension system, then transferring the data track from the data storage extension system to the primary storage system; if the data track is not available in the data storage extension system, then accessing the data track from a disk storage system; wherein the data storage extension system is configured to cache data tracks in a compressed format.

In another aspect of the present invention, a computer program product comprising a computer useable medium including a computer readable program, wherein the computer readable program when executed on a computer causes the computer to implement a method of caching a plurality of data tracks in a data storage extension system is disclosed. The said computer program product includes computer usable program code for compressing at least one of the plurality of data tracks to a compressed format, computer usable program code for receiving a data track request from a primary storage system, computer usable program code for decompressing at least one of the plurality of data tracks to produce decompressed data tracks computer usable program code for transferring at least one of the decompressed data tracks to the primary storage system, computer usable program code for performing a determination of whether at least one of the plurality of data tracks in compressed format is stale and computer usable program code for deleting at least one of the plurality of data tracks in compressed format in response to the determination.

### BRIEF DESCRIPTION OF THE DRAWINGS

FIG. 1 is a system block diagram illustrating a data storage facility in accordance with an embodiment of the present invention;

FIG. 2 is a block diagram showing application contexts requesting data from a primary storage system, in accordance with an embodiment of the present invention;

FIG. 3 is a block diagram showing message exchange between primary and extension data storage systems, in accordance with an embodiment of the present invention;

FIG. 4 is a state transition diagram showing various states of data storage and transitions among the states, in accordance with an embodiment of the present invention;

FIG. 5 is a flowchart showing the steps of data staging performed in the primary storage system, in accordance with an embodiment of the present invention;

FIG. 6 is a flowchart showing the steps of storing data in a storage extension system, in accordance with an embodiment of the present invention; and

FIG. 7 is a flow chart showing the steps of managing data stored in a storage data extension system, in accordance with an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

As used herein, the term “data track” refers to a quantum of data without any assumption about its size, syntax, addressing or whether the data is stored in a contiguous or fragmented manner.

Broadly, embodiments of the present invention provide for increasing available cache capacity for data caching in a storage facility. Example storage facility includes the DS8000 disk storage system made by International Business Machines (IBM®).

Increasing available data caching capacity in a prior art storage system requires installation of additional memory hardware and configuration of the storage controller to use the additional memory. This task may be cumbersome and expensive and may limit the amount of additional memory that can be added to the storage controller. In contrast to the prior art, the data storage extension system of the present invention interfaces with the primary storage system via a control interface such that the execution of data caching/staging in the primary storage system is not impeded by non-availability of the data storage extension system or compressed/cached data. Therefore, the present invention advantageously gets around the problems of memory expansion constrained by physical limitations in the storage controller. Also, because the data storage extension system is separated from the main data storage system, there is a reduced chance of an impact on data availability by the addition of features such as compressed caching features to the data storage extension system.

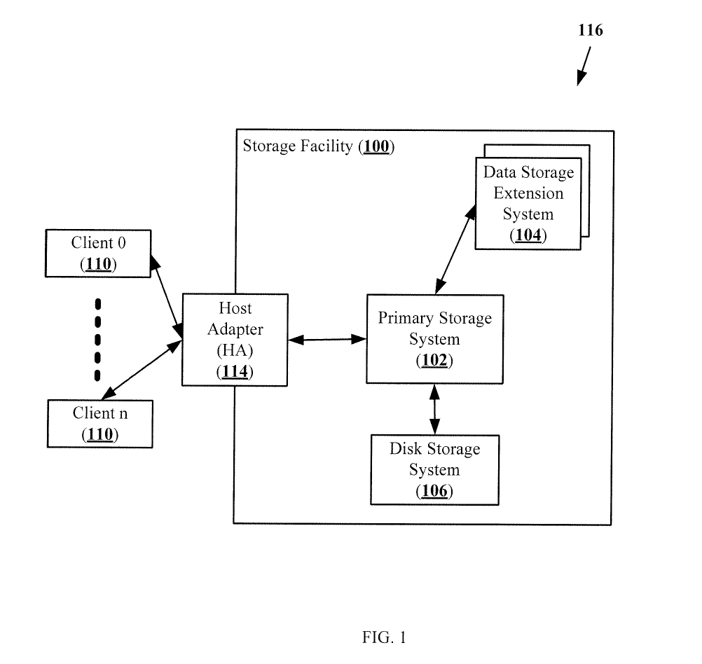

FIG. 1 illustrates a system 116 showing a storage facility 100 in accordance with an embodiment of the present invention. A primary storage system 102 communicates with multiple clients 110, shown as Client 0 through Client n, through a host adapter (HA) 114. The primary storage system is also connected to disk storage system 106 and a data storage extension system 104. The primary storage system may also include a primary cache, not shown in the figure, the primary cache is used for staging data tracks.

An exemplary embodiment may be possible consistent with the above description using an IBM DS8000 disk storage system as the storage facility 100, a storage facility image logical partition (SFI LPAR) as the primary storage system 102 and a storage extension LPAR (SE LPAR) as the data storage extension system 104.

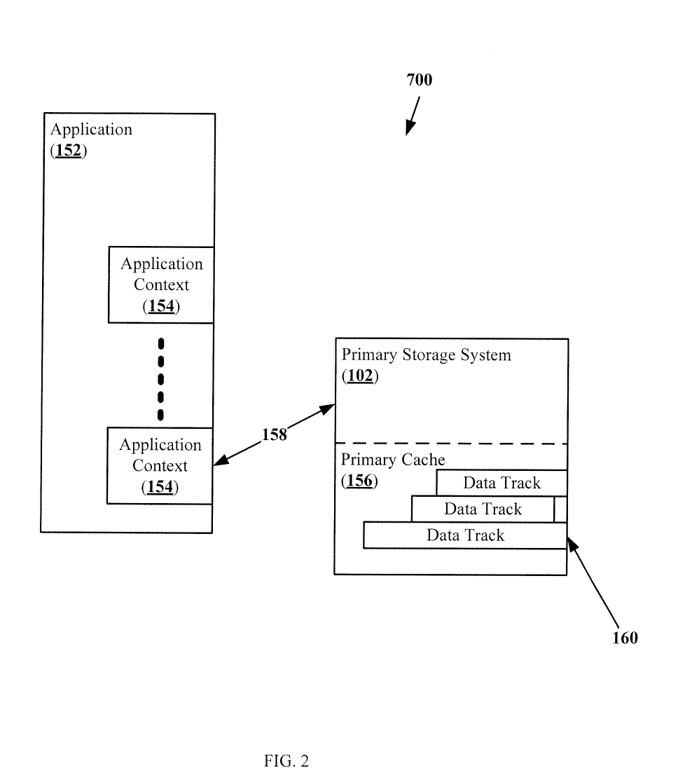

FIG. 2 shows a block diagram of a system 700 of application contexts requesting application 152 comprising multiple application contexts 154 requesting data by sending a data request REQ 158 to the primary storage system 102. A client 110 may be running several applications 152 at any given time, each application 152 making its own data requests 158. The primary storage system 102 may be organized in terms of a primary memory 156 that containing data tracks 160.

The primary storage system 102 may be responsible for the basic input/output of data tracks 160. The primary storage system 102 may also include caching function and other data management functions (not shown in the figure). A plurality of data storage extension systems 104 represents a variety of storage extension functions which can be added to the storage facility 100 by an implementer or a user of the storage facility 100. In accordance with the present invention, the primary storage system 102 may be designed to continue operations even if the data storage extension system 104 is not available (for example, if it has crashed). Such fault-tolerant implementation of a primary storage system 102 and data storage extension systems 104 provides several benefits. One benefit of such architecture is that the data storage extension system 104 can be implemented at a lower (development and test) cost because the harm caused by mistakes in their design/implementation are not as harmful as they would be if they were directly incorporated in the primary storage system 102. Another benefit includes the ability to incrementally provide new storage extension functions without having to significantly modify the primary storage system 102.

One exemplary embodiment of such a system would be a storage controller built on a server platform, with the primary storage system 102 operating in one virtual machine and the data storage extension system 104 operating in another virtual machine.

The data storage extension system 104 may perform one or more storage extension functions such as analysis of data tracks 160 to avoid data duplication, virus checking and implementation of advanced cache policy engines such as the C-Miner method for mining block correlations available at http://citeseer.ist.psu.edu/706735.html. to provide efficient management of available cache capacity.

Various embodiments for addition of storage extension functions in a storage facility 100 using a data storage extension system 104 are further described below using an illustrative example wherein the storage extension system 104 performs compression of cached data tracks 160.

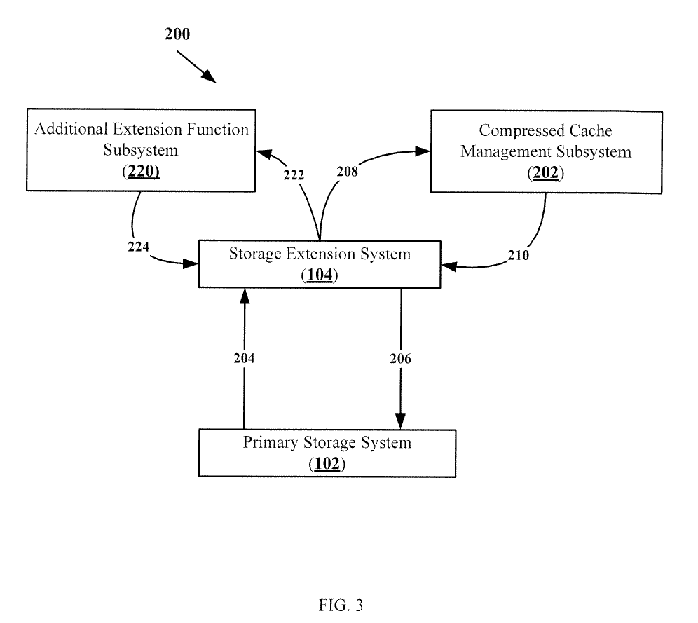

FIG. 3 shows a block diagram illustrating an example flow of control messages in a system 200 between the primary storage system 102 and one or more data storage extension systems 104. FIG. 3 shows two data storage extension systems: a compressed cache management system 202 and an additional extension functional subsystem 220. As described before, exemplary additional functional subsystems include a subsystem that performs virus check, a subsystem that implements smart cache management, and so on. Messages 204 from the primary storage system 102 to the data storage extension system 104 include requests for cached data tracks. Messages 206 from the data storage extension system 104 to the primary storage system 102 include responses to the requests for cached data tracks. The data storage extension system 104 is further shown connected to a compressed cache management subsystem 202 that is a logical functional subsystem within the data storage extension system. Messages 208 show communication from the data storage extension system 104 to the compressed cache management subsystem and messages 210 show communication in the reverse direction. The subsystem 202 may perform the functions of compression and decompression of cached data, purging of unwanted cached data and enforcement of cache allocation rules. One such example is provided by Ian McDonald in a Technical Report of the Department of Computing Sciences, University of Glasgow, titled “The use of Compressed Cache in an Operating System supporting Self-Paging” published on Sep. 8, 1999 and available at http://citeseer.ist.psu.edu/mcdonald99use.html.

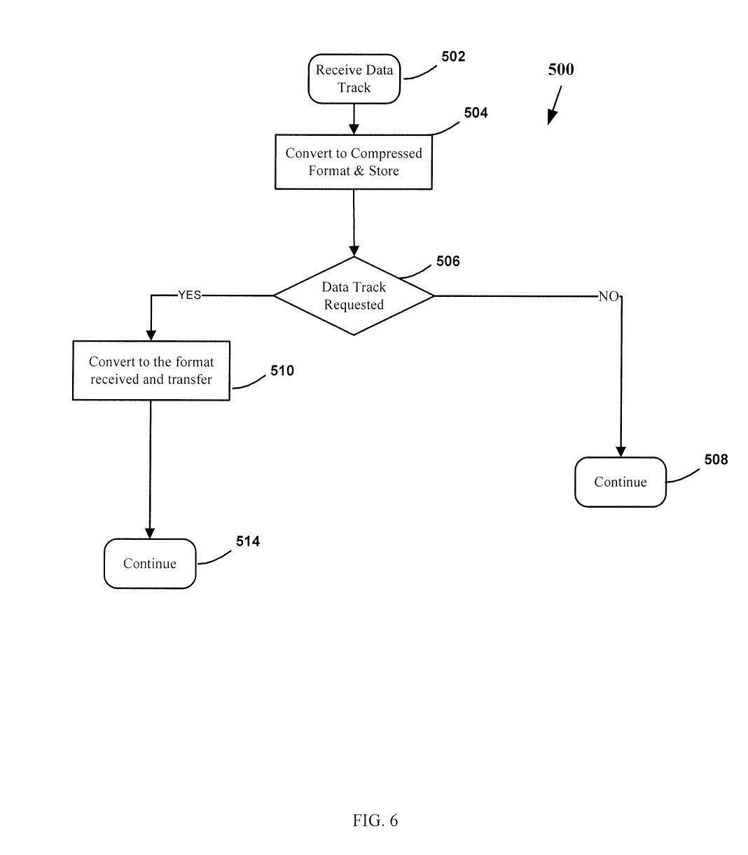

The messages 204 and 206 exchanged across the interface between primary storage system 102 and data storage extension system 104, such as data track request messages 204 transmitted in step 506 in FIG. 6 described further below, may be configured to operate so that if the data storage extension system 104 does not respond to a message request, the primary storage system 102 can continue performing data storage and caching operations. Such an arrangement of signal exchanges ensures that even in the absence of the data storage extension system 104, or when the data storage extension system 104 has failed, the primary storage system 102 is able to execute data caching operations successfully.

Message 224 the additional extension function subsystem 220 to the primary storage system 102 may include a registration message by which the additional extension function subsystem 220 makes its presence known to the primary storage system 102. The registration message 224, for example, may contain information regarding capabilities of the additional extension function subsystem 220. The registration message 224 may also contain information about events occurring in the primary storage system 102 that should trigger a notification message 222 to the additional extension function subsystem 220. For example, an additional extension function subsystem 220 implementing virus scan function may want the primary storage system 102 to notify if a write operation is performed within certain address range. Message 222 from the primary storage system 102 to the additional extension function subsystem 220 comprises notification, based on the information requested by the additional function extension subsystem 220, and other control messages related to checking integration, control or status information (failure/success or available/not available).

The discussion above exemplifies a method of adding a new functionality to a primary storage system 102 may include establishing communication between the primary storage system 102 and an extension function subsystem 104, registering capabilities of the extension function subsystem 104 with the primary storage system 102, specifying to the primary storage system 102 one or more events, e.g., “if data tracks are written to in a memory range, notify me” or “notify me of every data track read request”; and if the event occurs, sending a message from the primary storage system 102 to the extension function subsystem 104.

The data storage extension system 104 may store data by first performing data compression. Such data compression may be achieved using industry standard data compression algorithms such as the Lempel-Ziv-Oberhumer (LZO) encoding, or the Ziv-Lempel algorithm published by J. Ziv and A. Lempel in a paper titled “A universal algorithm for sequential data compression” in the IEEE Transactions on Information Theory, 23:337-343, 1977. Compression before storage allows the data storage extension system 104 to store more quantity of data than otherwise.

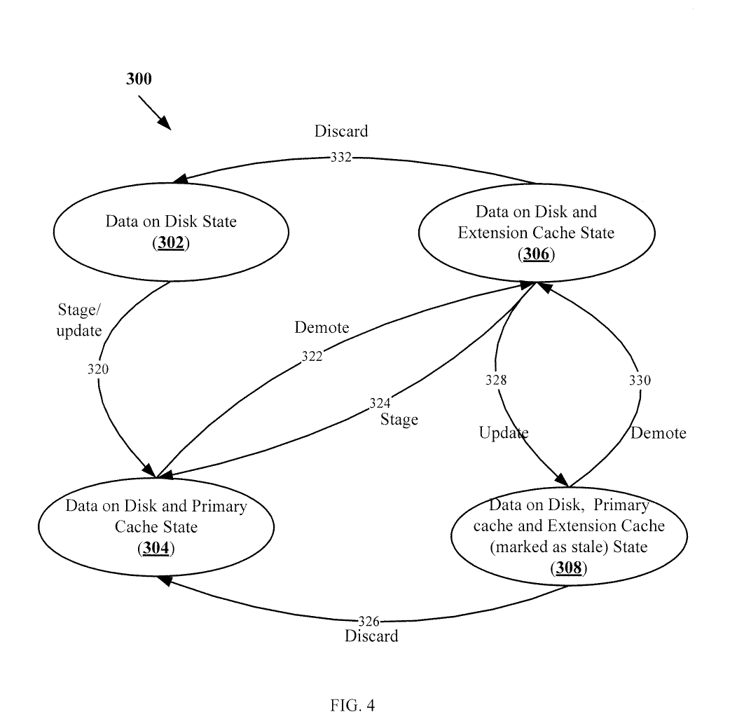

FIG. 4 shows a state transition diagram 300 showing exemplary states of transfer and storage of data tracks and state transitions in accordance with an embodiment of the present invention. Each state in the figure generally reflects distribution of data tracks 160 requested by an application context 154 among primary memory 156, disk storage system 106 and storage extension memory 104, as shown in FIG. 1.

When the primary storage system 102 receives a first request REQ 158 from an application context 154 executed at a Client 110 for data tracks 160, the data tracks 160 in general will be available in disk storage system 106. The state wherein the data tracks are in disk storage system 106 is shown as state 302. In response to the request REQ 158, the primary storage system 102 may fetch the requested data from disk storage system 106 into the primary memory 156 for transfer to the requesting application 152 and also speculatively cache more data tracks 160 into the primary memory 156. This movement of data causes a transition 320 to state 304. In state 304, the data tracks 160 for the requesting application may now be available partly in disk storage system 106 and partly in the primary memory 156.

From time to time during the operation, the primary storage system 102 may need to reclaim memory in the primary cache 156 by removing some data cached in the primary cache 156. The primary storage system 102 may do so by demoting (transition 322) some data to the data storage extension subsystem 104. The primary storage system 102 may make decisions about which data tracks 160 to demote based on a variety of criteria. For example, in one embodiment the decision to demote may be based on the amount of time the data tracks 160 were held in the primary cache 156. In another embodiment, the decision may be based on a priority associated with the requesting application 152, such that data tracks 160 for a lower priority application 152 may be demoted to make space for caching of data tracks 160 for a higher priority application 152.

When the primary storage system 102 has moved part or all of the cached data tracks 160 for an application context 154, data for the requesting application context 154 may now be available in two places: in the disk storage system 106 and in the data storage extension system 104. This distribution of data tracks 160 within the storage facility 100 is represented as state 306. In some embodiments, the primary storage system 102 may also retain some of the previously cached data tracks 160 for an application context 154 in the primary cache 156. While in other embodiments, the primary storage system 102 may demote all data tracks 160 cached in response to a requesting application context 154 to the data storage extension system 104.

The primary storage system 102 may or may not further use the data tracks 160 transferred as described above to the data storage extension system 104. For example, the data tracks may never get used during the fulfillment of the request 158 and the data storage extension system 104 may discard the data tracks 160, resulting in a transition 332 back to state 302, in which the data tracks 160 for the requesting application context 154 are located only on the disk storage system 106 within the storage facility 100 Another possibility for the data tracks 160 stored in the data storage extension system 104 is that the primary storage system 102 may decide to stage the data tracks back; as shown by transition 324; into the primary cache 156. The transitions shown in the figure are: stage/update 320, demote 322, stage 324, discard 326, update 328, demote 330 and discard 332. An “update” occurs when an application context 154 writes a data track 160 to the primary storage system 102. A “stage” occurs when an application context 154 reads a data track 160 from the primary storage system 102. In one embodiment, the primary storage system 102 and the data storage extension system 104 may be configured to operate in a “write-through” manner, wherein a data track 160 written to the primary storage system 102 is simultaneously written to the storage extension system 104. In another embodiment, called “write-back” manner, a data track 160 is updated only in the cache marked dirty and eventually “destaged” to the hard disk 106. When an update occurs, the data storage extension system 104 may be informed that a data track 160 it has is stale, so that it can mark it as such. In this method, the data storage extension system 104 will not transfer back stale data tracks 160 to the primary storage system 102 and this allows the compressed cache to discard stale data tracks 160. When transferring the data tracks 160 back into the primary cache 156, the data storage extension system 104 may mark the data tracks 160 stored in the data storage extension system 104 as “stale.” Thus, data for the requesting application context 154 may now be present in disk storage system 106, in the primary cache 156, and in the storage extension system 104 marked as “stale” state 308. This state of data track storage is shown as state 308 in FIG. 4 and the transition from state 306 to state 308 is shown by the arrow 328. In state 308, a data track 160 is present in all three places, but the compressed cache's data is stale. When the primary cache 156 decides to demote the data track 160, it sends the data track 160 to the compressed cache (transition 322). This results in the primary cache 156 having no copy of the data track 160 any longer, and the compressed cache having the current copy of the data track 160. Thus the compressed cache can remove the “stale” mark from the data track 160. Note that this transition may require an actual data track 160 transfer, not just a control message to remove the “stale” mark. Transition 328 may facilitate efficient management of the storage capacity of the storage extension system 104 by identifying data tracks 160 that can be deleted. The data storage extension system 104 may periodically discard data tracks 160 from memory, based on a set of rules. For example, the data storage extension system 104 may periodically discard stale data tracks 160 from its memory. This will result transition 326 back to state 304 wherein data tracks 160 are available on disk storage system 106 and in the primary cache 156. The data storage extension system 104 may also demote (transition 330) data marked as stale by removing the “stale” mark, reverting back to state 306.

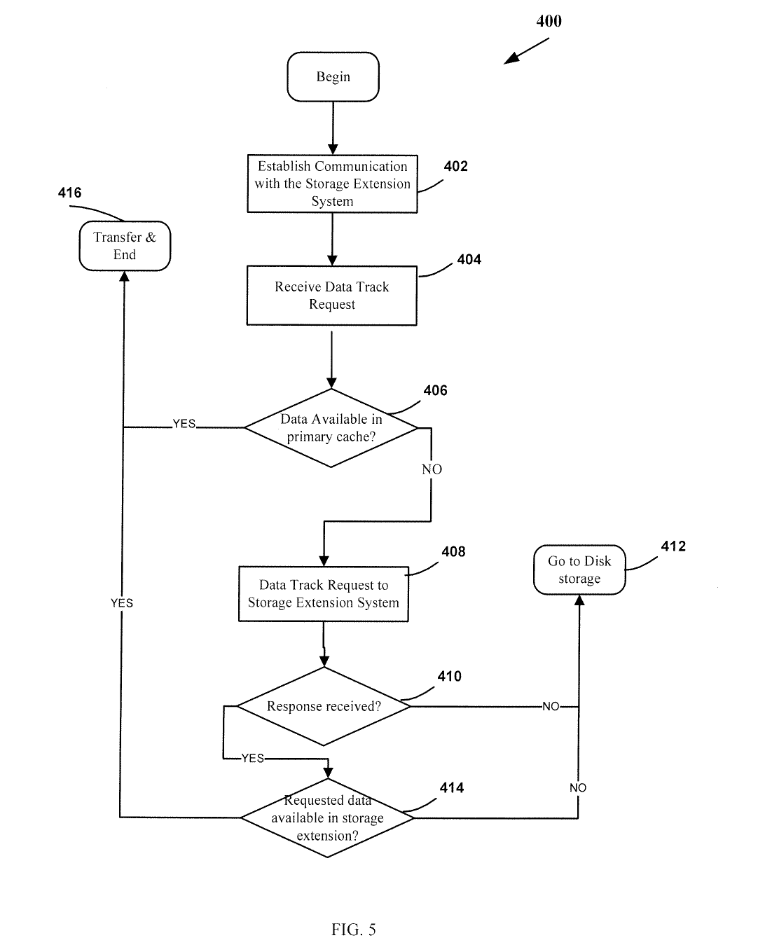

FIG. 5 shows a flowchart illustrating an example of a method 400 including steps of data staging performed in the primary storage system 102, in accordance with an embodiment of the present invention. The first step 402 may be of establishing communication between primary storage system 102 and a data storage extension system 104. The primary storage system may now become aware of the presence of a data storage extension system 104. In step 404, the primary storage system 102 receives a request 158 from an application context 154 for one or more data tracks 160. The application context 154 may be running at Client 0 110 and communicated with the storage facility 100 via the host adapter 114. The request 158 may also be generated by an application context 154 of a computer program (not shown in the figure) executed in the storage facility 100. In step 406, the primary storage system 102 may check availability of the requested data tracks 160 in the primary cache 156. If the requested data tracks 160 are available in the primary cache 156, the primary storage system 102 may then transfer the data tracks 160 in step 416 to the application context 154 that requested the data tracks 160. If the requested data tracks 160 are not available in the primary cache 156, the primary storage system 102 may then perform step 408 of querying the data storage extension system 104 for availability of the data tracks 160, by sending a data request message 204. The primary storage system 102 may at any given time have multiple such communications ongoing with the storage extension system 104; each communication for an independent application context 154.

The primary storage system 102 may perform the next step of deciding availability of the data tracks 160 within the data storage extension system 104 as follows. The data tracks 160 requested by the primary storage system 102 may either be available at the data storage extension system 104 or they may not be available. The data storage extension system 104 may reply back (message 206 in FIG. 3) to the request 204 and convey availability of the requested data with a yes/no answer. The primary storage system 102 may wait in step 410 to receive a response 206 back from the data storage extension system 104. If the primary data system 102 receives a response 206 that the requested data is available (step 414), then the primary data system 102 may perform the next step 416 of transferring the data tracks 160 from the data storage extension system 104 to the primary storage system 102. In some embodiments, step 416 may be implemented such that the response 206 from the data storage extension system 104 may itself be initiation of transfer of the requested data tracks 160.

If the primary storage system 102 receives no response 206 (“NO” branch of step 410), or if the response indicates that the requested data tracks 160 are not available (“NO” branch of step 414), the primary storage system 102 may then proceed to step 412 of accessing the data tracks 160 by checking if the requested data tracks 160 are available in the disk storage system 106. In various embodiments, the primary storage system 102 may get an explicit “data not available” reply 206 back from the storage extension system 104 or may infer non-availability based on the lack of any response from the data storage extension system 104 to the data request 204. Making such inference allows the primary storage system 102 to seamlessly handle situations when the data storage extension system 104 is busy or is not available due to a failure in the data storage extension system 104. The primary storage system 102 may use any of the several well known techniques such as a timeout based on some wait time before it infers that the data storage extension system 104 does not have the requested data tracks 160.

FIG. 6 shows a flowchart illustrating an example of a method 500 including steps taken by the data storage extension system 104 to manage transfer of data tracks 160 in and out of its memory. In step 502, the data storage extension system 104 receives a data track 160 from the primary storage system 102. The data track 160 may for example be received as a result of the demote transition 322 as described above. In the next step 504, the storage extension system 104 converts the received data track 160 to the format used for storage in the storage extension system 104. The data storage extension system 104 may perform the conversion “on the fly”, that is, as the data track 160 is being transmitted from the primary storage system 102 to the data storage extension system 104. Alternatively, the storage extension system 104 may perform the conversion after receiving the data track 160. In the preferred embodiment of the present invention, data compression is used for the conversion at the data storage extension system 104. Use of data compression allows the data storage extension system 104 to store more data tracks 160 in the same physical memory, thereby increasing the data storage extension system's effective data storage capacity. Any of the several well known data compression algorithms, such as the LZO algorithm or the LZV algorithm, may be used to for compression.

When the data storage extension system 104 receives a data track request 204 in step 506 from the primary storage system 102, the data storage extension system 104 first checks availability of the requested data track 160. In one embodiment, this check may be performed by sending a message 208 to a compressed cache management subsystem 202 and receiving a response 210 back from the compressed cache management subsystem 202. If the data track 160 is not available, the storage extension system 104 may perform further tasks 508. Exemplary further tasks 508 may include sending a response 206 back to the primary storage system 102 indicating non-availability of the requested data track 160 or not responding at all to the primary storage system 102. If the requested data track 160 is available in step 506, the data storage extension system 104 may then proceed, in step 510, to reformat the data track 160 back to the format in which it was received. For example, compressed data tracks 160 will be decompressed back into uncompressed format. In some embodiments of step 510, the data storage extension system 104 may also begin transferring the reformatted data tracks 160 to the primary storage system 102. In other embodiments, the data storage extension system 104 may reformat data tracks 160 in step 510 and notify the primary storage system 102. The primary storage system 102 may then transfer the reformatted data tracks 160 into its primary cache 156. The data storage extension system 104 then proceeds with further tasks 514, which may include attending to more data requests from the primary storage system 102.

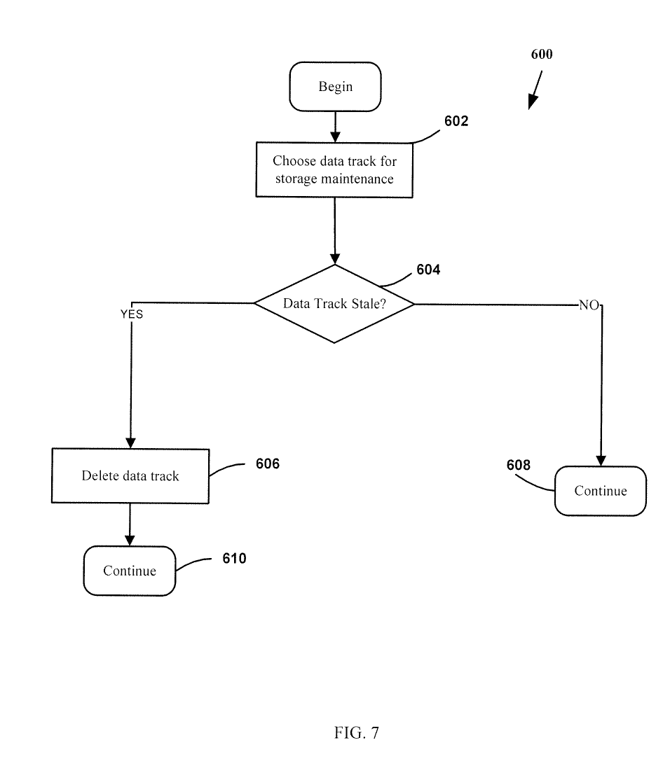

FIG. 7 shows a flowchart illustrating an example of a method 600 including steps of memory management and maintenance of data tracks 160 in the data storage extension system 104. In step 602, the data storage extension system 104 chooses one or more data tracks 160 for maintenance. The data storage extension system 104 may first check, in step 604, if the data tracks 160 are marked as “stale.” If the data tracks 160 are not marked as stale, the data storage extension system 104 continues with further tasks 608. If the data tracks 160 are marked as stale, then the data storage extension system 104 may delete the data tracks 160 in step 606 and continue with further tasks 610. In various embodiments, the data storage extension system 104 may be configured to implement various data track maintenance policies, including policies where some non-stale data tracks 160 may be discarded before any stale data tracks 160 are discarded.

The data storage extension system 103 may implement the steps described above to minimize or eliminate duplication of data tracks 160 between data storage extension system 104 and the primary cache 156. Such avoidance of duplication further results in efficient use of capacity of the primary cache 156 and the data storage extension system's storage capacity. Such avoidance therefore makes efficient use of the total cache capacity available in the storage facility 100.

The invention can take the form of an entirely hardware embodiment, an entirely software embodiment or an embodiment containing both hardware and software elements.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It should be understood, of course, that the foregoing relates to exemplary embodiments of the invention and that modifications may be made without departing from the spirit and scope of the invention as set forth in the following claims.

We claim:

1. A method of adding a new functionality to a primary storage system comprising steps of:
establishing communication between said primary storage system and an extension function subsystem;
registering capabilities of said extension function subsystem with said primary storage system;
specifying to the primary storage system at least one event; and
if the event occurs, sending a message from the primary storage system to the extension function subsystem.

2. The method of claim 1, wherein the primary storage system is configured to continue operations without the extension function subsystem when communication with the extension function subsystem fails.

3. The method of claim 1 wherein the new functionality increases available cache capacity of a primary storage system; the method further comprising the steps of
querying said data storage extension system for availability of a data track;
deciding availability of said data track within said data storage extension system; and
if said data track is available in said data storage extension system, then transferring said data track from said data storage extension system to said primary storage system;
if said data track is not available in said data storage extension system, then accessing said data track from a disk storage system;
wherein said data storage extension system is configured to perform at least one storage extension function.

4. The method of claim 3 wherein said storage extension function includes caching said data tracks in a compressed format.

5. The method of claim 4 wherein said data storage extension system deletes said data track in response to transferring said data track from said data storage extension system to said primary storage system.

6. The method of claim 3, wherein said data storage extension system marks said data track as stale in response to transferring said data track from said data storage extension system.

7. The method of claim 3, wherein said step of deciding further comprises receiving a response from said data storage extension system.

8. The method of claim 3, wherein said step of deciding comprises inferring from lack of response from said data storage extension system that said data track is not available within said data storage extension system.

9. A method of caching a plurality of data tracks in a data storage extension system comprising the steps of:
compressing at least one of said plurality of data tracks to a compressed format;
receiving a data track request from a primary storage system;
decompressing at least one of said plurality of data tracks to produce decompressed data tracks;
transferring at least one of said decompressed data tracks to said primary storage system;
performing a determination of whether at least one of said plurality of data tracks in compressed format is stale; and
deleting at least one of said plurality of data tracks in compressed format in response to said determination.

10. The method of claim 9 wherein said data storage extension system performs said step of decompressing in response to a data request from an application.

11. The method of claim 9 wherein said determination of whether said at least one of said plurality of data tracks in compressed format is stale is responsive to passage of time since storage of said at least one of said plurality of data tracks in said compressed format.

12. The method of claim 9 wherein said determination of whether said at least one of said plurality of data tracks in compressed format is stale includes checking whether said at least one of said plurality of data tracks in compressed format was transferred to said primary storage system.

13. A computer program product comprising a computer useable medium including a computer readable program, wherein the computer readable program when executed on a computer causes the computer to increase available cache capacity of a primary storage system; said computer program product including;
computer usable program code for communicating with a plurality of application instances;
computer usable program code for establishing communication between said primary storage system and a data storage extension system;
computer usable program code for querying said data storage extension system for availability of a data track;
computer usable program code for deciding availability of said data track within said data storage extension system; and
if said data track is available in said data storage extension system, then transferring said data track from said data storage extension system to said primary storage system;
if said data track is not available in said data storage extension system, then accessing said data track from a disk storage system;
wherein said data storage extension system is configured to cache data tracks in a compressed format.

14. The computer program product of claim 13 further including computer usable program code for deleting said data track in response to the step of transferring said data track from said data storage extension system to said primary storage system.

15. The computer program product of claim 13, further including computer usable program code for periodically discarding said data tracks.

16. The computer program of claim 13, further including computer usable program code for decompressing said data track.

17. A computer program product comprising a computer useable medium including a computer readable program, wherein the computer readable program when executed on a computer causes the computer to implement a method of caching a plurality of data tracks in a data storage extension system; said computer program product including;
computer usable program code for compressing at least one of said plurality of data tracks to a compressed format;
computer usable program code for receiving a data track request from a primary storage system;
computer usable program code for decompressing at least one of said plurality of data tracks to produce decompressed data tracks;
computer usable program code for transferring at least one of said decompressed data tracks to said primary storage system;
computer usable program code for performing a determination of whether at least one of said plurality of data tracks in compressed format is stale; and
computer usable program code for deleting at least one of said plurality of data tracks in compressed format in response to said determination.

18. The computer program product of claim 17 further including computer usable program code for periodically discarding said data tracks.

19. The computer program product of claim 17 further including computer usable program code for determination of whether said at least one of said plurality of data tracks in compressed format is stale; said determination responsive to passage of time since storage of said at least one of said plurality of data tracks in said compressed format.

20. The method of claim 1 wherein said extension function subsystem analyzes data to avoid data duplication.
